(19) United States
(12) Patent Application Publication
(10) Pub. No.: US 2024/0152153 A1
(43) Pub. Date: May 9, 2024

(54) APPARATUS AND METHOD FOR CONTROLLING PLATOONING

(71) Applicant: HYUNDAI MOBIS Co., Ltd., Seoul (KR)

(72) Inventor: Heung Rae CHO, Seongnam-si (KR)

(73) Assignee: HYUNDAI MOBIS Co., Ltd., Seoul (KR)

(21) Appl. No.: 18/088,975

(22) Filed: Dec. 27, 2022

(30) Foreign Application Priority Data
Nov. 3, 2022 (KR) 10-2022-0145278

(51) Int. Cl. G05D 1/02; G06V 10/82; G06V 20/58; H04B 17/318

(52) U.S. Cl. CPC G05D 1/0295; G05D 1/0221; G05D 1/0223; G05D 1/0289; G06V 10/82; G06V 20/58; H04B 17/318; G05D 2201/0213

(57) ABSTRACT

Proposed are apparatus and control method for platooning, the apparatus including a learning device which performs reinforcement learning based on a feedback signal and video information and controls driving of a host vehicle based on a result of the reinforcement learning such that a rear vehicle can follows a driving trajectory of the host vehicle, and a reward determination part which generates the feedback signal by comparing coordinates of the rear vehicle with coordinates of control points for the driving trajectory of the host vehicle.

### CROSS REFERENCE TO RELATED APPLICATION

The present application claims priority to Korean Patent Application No. 10-2022-0145278, filed Nov. 3, 2022, the entire contents of which are incorporated herein for all purposes by this reference.

### TECHNICAL FIELD

The present disclosure relates to an apparatus for controlling platooning which performs reinforcement learning such that platooning can be performed stably and efficiently, and a method for controlling platooning.

### BACKGROUND

Generally, platooning means that a plurality of vehicles grouped together shares driving information with each other and travels on a road while considering an external environment.

In order to stably perform platooning, it is important to properly maintain a distance between platooning vehicles and to control a rear vehicle to follow the driving trajectory of a front vehicle.

An autonomous driving system may perform reinforcement learning for platooning so that an autonomous vehicle takes an optimal action during platooning.

The reinforcement learning, which is one of machine learning methods, is to learn which action is optimal to take in a current state through trial and error. Whenever an action is taken, a reward is given and learning proceeds in the direction of maximizing this reward.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose an apparatus for controlling platooning which performs reinforcement learning by using video information and control points for the driving trajectory of a host vehicle during platooning such that the platooning can be stably and efficiently performed.

Technical objectives to be achieved in the present disclosure are not limited to the technical objective mentioned above, and other technical objectives not mentioned above will be clearly understood to those skilled in the art to which the present disclosure belongs from the following description.

In order to achieve the above objective, there is provided an apparatus for controlling platooning, the apparatus including: a learning device which performs reinforcement learning based on a feedback signal and video information output from a camera provided in each of a host vehicle and a rear vehicle which are platooning, and controls driving of the host vehicle based on a result of the reinforcement learning such that the rear vehicle can follows a driving trajectory of the host vehicle; and a reward determination part which obtains coordinates of the rear vehicle and generates the feedback signal by comparing the coordinates of the rear vehicle with coordinates of control points for the driving trajectory of the host vehicle.

In addition, in order to achieve the above objective, there is provided a method for controlling platooning, the method including: performing the reinforcement learning based on the feedback signal and the video information output from the camera provided in each of the host vehicle and the rear vehicle which are platooning; controlling driving of the host vehicle such that the rear vehicle follows the driving trajectory of the host vehicle based on the result of the reinforcement learning; and generating the feedback signal by comparing coordinates of the rear vehicle with coordinates of the control points for the driving trajectory of the host vehicle after obtaining the coordinates of the rear vehicle.

In addition, in order to achieve the above objective, the method for controlling platooning includes: determining whether a ratio of a first distance between coordinates of the host vehicle and coordinates of a front vehicle in platooning to a second distance between the coordinates of the host vehicle and coordinates of a separate vehicle is included in a preset range when the separate vehicle other than the platooning front vehicle is recognized from a front of the host vehicle in platooning; generating the feedback signal according to a result of the determination; performing the reinforcement learning based on the feedback signal and the video information output from the camera provided in each of the host vehicle and the front vehicle; and controlling driving speed of the host vehicle such that the ratio of the first distance to the second distance is included in the preset range based on the result of the reinforcement learning.

According to the present disclosure, the reinforcement learning is performed by using the video information and the control points for the driving trajectory of the host vehicle during platooning, so the host vehicle can stably and efficiently lead a vehicle behind the host vehicle.

In addition, even when a separate vehicle cuts in a platooning formation or a separate vehicle cutting in the platooning formation cuts out of the platooning formation, the platooning formation can be managed stably and efficiently.

Effects obtainable from the present disclosure are not limited to effects described above, and other effects not described above will be clearly appreciated from the following description by those skilled in the art.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating one example of the configuration of an apparatus for controlling platooning according to an embodiment of the present disclosure;

FIG. 2 is a sequence diagram illustrating the process of exchanging information between a host vehicle and a rear vehicle during platooning according to the embodiment of the present disclosure;

FIG. 3 is a diagram illustrating the front and rear videos of platooning vehicles according to the embodiment of the present disclosure;

FIG. 4 illustrates an example of the process of generating control points for the driving trajectory of a front vehicle according to the embodiment of the present disclosure;

FIG. 5 illustrates an example of the process of determining distances between the host vehicle, the rear vehicle, and a separate vehicle according to the embodiment of the present disclosure;

FIG. 6 is a flowchart illustrating the process of performing feedback for the reinforcement learning based on the control points for the driving trajectory of the host vehicle according to the embodiment of the present disclosure;

FIG. 7 is a view illustrating the process of performing feedback according to the coordinates of the rear vehicle during platooning according to the embodiment of the present disclosure;

FIG. 8 is a flowchart illustrating the process of performing feedback on the reinforcement learning based on a distance between a plurality of vehicles when the host vehicle is the front vehicle in the embodiment of the present disclosure; and

FIG. 9 is a flowchart illustrating the process of performing feedback on the reinforcement learning based on a distance between a plurality of vehicles when the host vehicle is the rear vehicle in the embodiment of the present disclosure.

### DETAILED DESCRIPTION

Hereinafter, an embodiment disclosed in the present specification will be described in detail with reference to the accompanying drawings, but the same or similar components regardless of reference numerals are assigned the same reference numerals, and overlapping descriptions thereof will be omitted. Terms “module” and “part” for the components used in the following description are given or mixed in consideration of only the ease of writing the specification, and do not have distinct meanings or roles by themselves. In addition, when it is determined that detailed descriptions of related known technologies may obscure the gist of the embodiment disclosed in this specification in describing the embodiment disclosed in the present specification, the detailed description thereof will be omitted. In addition, the accompanying drawings are only for easily understanding the embodiment disclosed in this specification, and do not limit the technical idea disclosed herein, and should be understood to cover all modifications, equivalents or substitutes falling within the spirit and scope of the present disclosure.

Terms including an ordinal number, such as first and second, etc., may be used to describe various elements, but the elements are not limited by the terms. The terms are used only for the purpose of distinguishing one element from another.

It should be understood that when an element is referred to as being “coupled” or “connected” to another element, it may be directly coupled or connected to the another element, or intervening elements may be present therebetween. On the other hand, it should be understood that when an element is referred to as being “directly coupled” or “directly connected” to another element, there are no intervening elements present.

Singular forms include plural forms unless the context clearly indicates otherwise.

In the present specification, it should be understood that terms such as “comprises” or “have” are intended to designate that features, numbers, steps, operations, components, parts, or combinations thereof described in the specification exist, but do not preclude the possibility of the existence or addition of one or more other features, numbers, steps, operations, components, parts, or combinations thereof.

In the embodiment of the present disclosure, reinforcement learning is performed by using a feedback signal and video information output from a camera provided in each of a host vehicle and a rear vehicle during platooning so as to control the driving of the host vehicle such that the rear vehicle can follow the driving trajectory of the host vehicle.

More specifically, depending on a distance or angle between a host vehicle and a rear vehicle, it may be difficult for the rear vehicle to follow the driving trajectory of the host vehicle and be maintained in a platooning formation within a predetermined range, and accordingly, it is proposed that the rear vehicle can follow the driving trajectory of the host vehicle through the driving control of the host vehicle based on reinforcement learning.

A host vehicle, a rear vehicle, and a front vehicle appearing below refer to vehicles included in platooning formation, and a vehicle other than the vehicles in platooning is referred to as a separate vehicle.

In addition, the driving trajectory of a host vehicle may include a trajectory of a path through which the host vehicle has passed to this point, and a trajectory of a path determined according to the future driving of the host vehicle.

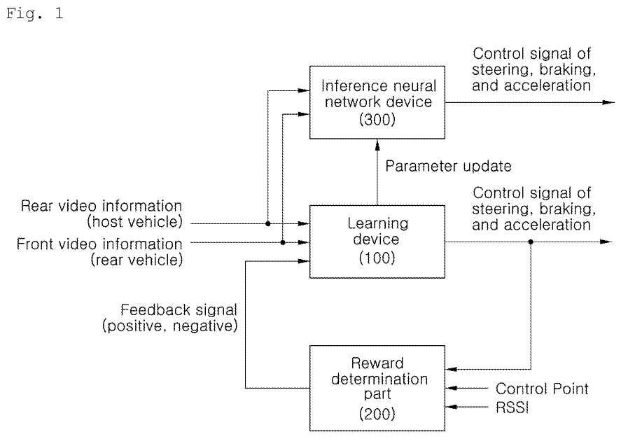

Prior to describing a method for controlling platooning control according to the embodiment of the present disclosure, the configuration of the apparatus for controlling platooning according to the embodiment will be described with reference to FIG. 1.

FIG. 1 is a block diagram illustrating one example of the configuration of the apparatus for controlling platooning according to the embodiment of the present disclosure.

As illustrated in FIG. 1, the apparatus for controlling platooning may include a learning device 100, a reward determination part 200, and an inference neural network device 300. FIG. 1 shows mainly components related to the present disclosure, and an actual platooning apparatus may include more or less components than the components of the present disclosure.

Hereinafter, each component of the apparatus for controlling platooning will be described.

First, the learning device 100 may correspond to an agent that is a target of the reinforcement learning for platooning.

The learning device 100 may perform reinforcement learning through a neural network based on a feedback signal and video information output from a camera provided in each of the host vehicle and the rear vehicle in platooning and may control the driving of the host vehicle such that the rear vehicle can follow the driving trajectory of the host vehicle according to the result of the reinforcement learning.

In this case, the learning device 100 may control driving of the host vehicle by outputting a steering control signal, a braking control signal, and an acceleration control signal.

The video information may include rear video information output from a rear camera of the host vehicle and front video information output from a front camera of the rear vehicle. The rear video information and the front video information correspond to the state of platooning and may reflect characteristics of a real road on which the host vehicle is currently driving.

Accordingly, the learning device 100 may control the rear vehicle to stably follow the driving trajectory of the host vehicle in an exceptional platooning situation by performing the reinforcement learning through the rear video information and the front video information corresponding to a current platooning state, thereby improving the performance of the host vehicle leading the rear vehicle.

A feedback signal may correspond to a reward for the reinforcement learning. More specifically, the feedback signal may indicate one of positive feedback and negative feedback regarding whether a host vehicle follows the driving trajectory of a vehicle in front of the host vehicle. Accordingly, the learning device 100 may maintain or modify a policy for the reinforcement learning according to the feedback signal.

The steering control signal, the braking control signal, and the acceleration control signal correspond to actions for the reinforcement learning. More specifically, the learning device 100 may control the driving state (e.g., driving direction and driving speed, etc.) of a host vehicle by transmitting a control signal required for driving the host vehicle to a controller related to driving such as steering, braking, and driving.

For example, the learning device 100 may output the steering control signal to a steering controller (not shown) which adjusts the rotation angle of a steering wheel so as to control a steering angle of the host vehicle, and may output the braking control signal to a braking controller (not shown) which adjusts the amount of hydraulic braking or a motor controller (not shown) which adjusts the amount of regenerative braking so as to control the braking amount of the host vehicle. In addition, the learning device 100 may output the acceleration control signal to an electric motor or a powertrain controller (not shown) which adjusts the output torque of an engine so as to control the acceleration of the host vehicle.

In addition, when controlling the driving speed of the host vehicle, the learning device 100 may decrease the possibility of collision during the driving control of the host vehicle by considering whether there is a front obstacle located within a predetermined range from the front of the host vehicle.

According to an exemplary embodiment of the present disclosure, the learning device 100 may include a processor (e.g., computer, microprocessor, CPU, ASIC, circuitry, logic circuits, etc.) and an associated non-transitory memory storing software instructions which, when executed by the processor, provides the functionalities described above. Herein, the memory and the processor may be implemented as separate semiconductor circuits. Alternatively, the memory and the processor may be implemented as a single integrated semiconductor circuit. The processor may embody one or more processor(s).

Meanwhile, the reward determination part 200 may generate a feedback signal corresponding to a reward for the reinforcement learning based on the steering control signal, the braking control signal, and the acceleration control signal corresponding to actions for the reinforcement learning.

In addition, the reward determination part 200 may obtain the coordinates of control points for the driving trajectory of the host vehicle from the host vehicle and the coordinates of the rear vehicle and may generate the feedback signal by comparing the coordinates of the control points with the coordinates of the rear vehicle.

In this case, the coordinates of the rear vehicle may be received and obtained from the rear vehicle or may be obtained through a sensor such as a camera, radar, or LiDAR provided in the host vehicle.

In addition, the reward determination part 200 may transmit the coordinates of the control points to the rear vehicle such that the rear vehicle follows the driving trajectory of the host vehicle based on the control points. Accordingly, the rear vehicle can drive while following the trajectory of the host vehicle through the transmitted control points, and the coordinates of the rear vehicle following the host vehicle based on the control points are generated to be considered in the reinforcement learning such that the reinforcement learning completeness of the learning device 100 can be improved.

In the embodiment, the control points may be defined as feature points which control the shape of a spline curve corresponding to the driving trajectory of the host vehicle.

The spline curve may correspond to a smooth curve representing the driving trajectory of the host vehicle by using a spline function. According to the embodiment, the spline curve may correspond to either an interpolating spline curve which passes through the control points or an approximating spline curve which does not pass through middle control points. Here, whether the approximating spline curve passes through a start control point and an end control point may be preset differently according to embodiments.

Hereinafter, assuming that the spline curve corresponding to the driving trajectory of the host vehicle corresponds to the approximating spline curve, the operation method of the reward determination part 200 for generating a feedback signal will be described.

When the coordinates of the rear vehicle are outside a driving lane compared to the coordinates of the control points, the reward determination part 200 may determine that the rear vehicle deviates from the driving trajectory of the host vehicle in the direction of the control points and may output the feedback signal as negative feedback. Here, the driving lane corresponds to a lane in which the rear vehicle is currently driving.

In addition, when the coordinates of the rear vehicle are outside a preset hazard distance from the coordinates of the control points, the reward determination part 200 may determine that the rear vehicle deviates from the driving trajectory of the host vehicle in a direction opposite to the direction of the control points, and may output the feedback signal as negative feedback.

In this case, when the coordinates of the rear vehicle are outside the driving lane compared to the coordinates of the control points or are outside a preset hazard distance from the coordinates of the control points, the learning device 100 may control at least one of the driving direction and driving speed of the host vehicle such that the rear vehicle can follow the driving trajectory of the host vehicle.

For example, the learning device 100 controls the braking amount of the host vehicle to be increased through the braking control signal, and controls the steering angle of the host vehicle to be decreased through the steering control signal, and thus can control the driving of the host vehicle such that the rear vehicle can follow the driving trajectory of the host vehicle.

Meanwhile, description of an order relation between the driving control of the host vehicle through the output of the steering control signal, the acceleration control signal, and the braking control signal by the learning device 100 and the output of a feedback signal by the reward determination part 200 will be omitted.

For example, according to the output of the feedback signal of the reward determination part 200, the learning device 100 may control the driving of the host vehicle, and unlike this, the feedback signal and the signal for the driving control of the host vehicle may be simultaneously output from the reward determination part 200 and the learning device 100, respectively.

Meanwhile, when the coordinates of the rear vehicle are inside the driving lane compared to the coordinates of the control points and are within a preset hazard distance from the control points, the reward determination part 200 may determine that the rear vehicle stably follows the driving trajectory of the host vehicle. In this case, the reward determination part 200 may output the feedback signal as positive feedback.

Accordingly, based on the coordinates of the control points for the driving trajectory of the host vehicle, the reward determination part 200 according to the embodiment provides feedback on whether the rear vehicle follows the driving trajectory of the host vehicle to the learning device 100 such that a data size and a calculation amount for the driving trajectory of the host vehicle can be decreased.

In addition, the reward determination part 200 may output the feedback signal as any one of positive feedback and negative feedback according to whether a first distance between the host vehicle and the rear vehicle is included in a preset first range.

For example, when the first distance between the host vehicle and the rear vehicle is included in the preset first range, the reward determination part 200 may determine that the rear vehicle stably maintains a distance from the host vehicle, and may output the feedback signal as positive feedback.

Unlike this, when the first distance between the host vehicle and the rear vehicle is not included in the preset first range, the reward determination part 200 may output the feedback signal as negative feedback.

In this case, when the first distance between the host vehicle and the rear vehicle is outside the preset first range, the learning device 100 may control the driving speed of the host vehicle such that the first distance between the host vehicle and the rear vehicle is included in the preset first range.

More specifically, when the first distance between the host vehicle and the rear vehicle exceeds the upper limit of the preset first range, the learning device 100 may perform the braking control of the host vehicle such that the first distance between the host vehicle and the rear vehicle is included in the preset first range.

Unlike this, when the first distance between the host vehicle and the rear vehicle is less than the lower limit of the preset first range, the learning device 100 may perform the acceleration control of the host vehicle such that the first distance between the host vehicle and the rear vehicle is included in the preset first range.

Meanwhile, the first distance between the host vehicle and the rear vehicle may be determined based on the received strength of a wireless signal received from the rear vehicle.

In this case, as the received strength of the wireless signal increases, a distance between the host vehicle and the rear vehicle decreases and thus the first distance may be considered to be small, and as the received strength of a wireless signal decreases, a distance between the host vehicle and the rear vehicle increases and thus the first distance may be considered to be great.

Here, the received strength of the wireless signal may be, for example, received signal strength indication (RSSI).

In addition, the preset first range for the first distance between the host vehicle and the rear vehicle may be preset in various ways according to embodiments.

Accordingly, through the received signal strength of the wireless signal, the reward determination part 200 according to the embodiment may provide feedback on whether the first distance between the host vehicle and the rear vehicle is stably maintained to the learning device 100, and the learning device 100 may learn the acceleration and braking characteristics of the host vehicle for the first distance between the host vehicle and the rear vehicle through the feedback provided from the reward determination part 200.

In the embodiment, the reward determination part 200 corresponds to a controller dedicated to feedback on the reinforcement learning of the learning device 100, and to this end, may include a communication device that communicates with other controllers or sensors, an operating system or a memory that stores logic commands and input/output information, and one or more processors that perform decision, calculation, and determination necessary for controlling a responsible function.

After the reinforcement learning for platooning performed in the learning device 100 has stabilized, the inference neural network device 300 may periodically update a parameter for the neural network included in the learning device 100.

The inference neural network device 300 may receive the front video information and the rear video information based on the updated parameter without feedback from the reward determination part 200 and may control the driving of the host vehicle such that the rear vehicle can follow the driving trajectory of the host vehicle.

In this case, like the learning device 100, the inference neural network device 300 may control driving of the host vehicle by outputting the steering control signal, the braking control signal, and the acceleration control signal.

Accordingly, after the reinforcement learning for platooning is stabilized, the inference neural network device 300 performs the steering control, braking control, and acceleration control of the host vehicle through only the video information without additional reinforcement learning such that the amount of computation for the reinforcement learning of the apparatus for controlling platooning can be reduced.

According to an exemplary embodiment of the present disclosure, the inference neural network device 300 may include a processor (e.g., computer, microprocessor, CPU, ASIC, circuitry, logic circuits, etc.) and an associated non-transitory memory storing software instructions which, when executed by the processor, provides the functionalities described above. Herein, the memory and the processor may be implemented as separate semiconductor circuits. Alternatively, the memory and the processor may be implemented as a single integrated semiconductor circuit. The processor may embody one or more processor(s).

According to the embodiment of the present disclosure described above, when controlling the driving of the host vehicle traveling at a relatively front side through the result of the reinforcement learning, a degree to which the rear vehicle following the host vehicle follows the driving trajectory thereof may be improved.

Through this, a degree to which rear vehicles following the rear vehicle follow the driving trajectory may also be improved serially, and in this case, for the vehicles behind the host vehicle, the platooning formation can be managed only with an existing following control, so the efficiency of overall platooning control can be improved.

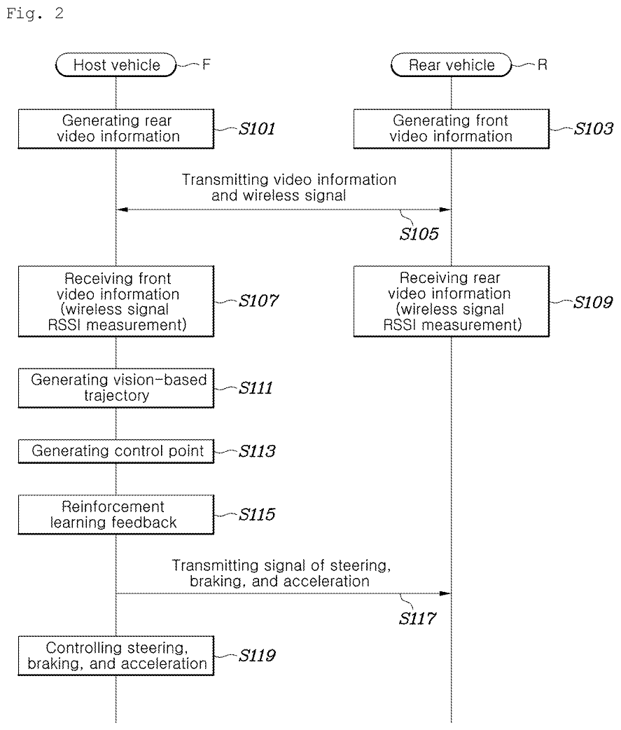

FIG. 1 illustrates components of the apparatus for controlling platooning according to the embodiment and a function performed by each of the components, and information exchange during platooning will be described with reference to FIG. 2 hereinafter.

FIG. 2 is a sequence diagram illustrating the process of exchanging information between a host vehicle and a rear vehicle during platooning according to the embodiment of the present disclosure.

In FIG. 2, it is assumed that the host vehicle F has components described above by referring to FIG. 1 and the rear vehicle R, which is a vehicle platooning together with the host vehicle F, is a vehicle which directly communicates with the host vehicle F or supports communication through infrastructure.

First, the host vehicle F may generate rear video information by downscaling and compressing video information output from the rear camera at S101, and the rear vehicle R may generate front video information by downscaling and compressing video information output from the front camera at S103.

Next, the host vehicle F may transmit the rear video information and the wireless signal to the rear vehicle R, and the rear vehicle R may transmit the front video information and the wireless signal to the host vehicle F at S105.

The host vehicle F may restore the received front video information and measure the received signal strength of the wireless signal received from the rear vehicle R at S107. Likewise, the rear vehicle R may restore the received rear video information and measure the received signal strength of the wireless signal received from the host vehicle F at S109.

The host vehicle F may generate a vision-based trajectory through the video information output from the rear camera and the front video information received from the rear vehicle R at S111, and may generate the coordinates of the control points according to the vision-based trajectory at S113.

In addition, the host vehicle F may transmit the coordinates of the control points to the rear vehicle R such that the rear vehicle R can follow the driving trajectory of the host vehicle based on the control points. Through this, the coordinates of the rear vehicle may correspond to the control points, and the coordinates of the rear vehicle R following the host vehicle F based on the control points may be considered in the reinforcement learning.

The host vehicle F may proceed feedback on the reinforcement learning based on the coordinates of the control points and the measured value of the received signal strength of a wireless signal at S115, and according to the embodiment, in order to control driving of the rear vehicle R according to the feedback, the steering control signal, the braking control signal, and the acceleration control signal may be transmitted to the rear vehicle R at S117.

After the feedback, according to the result of the reinforcement learning, the steering control, braking control, and acceleration control of the host vehicle F are performed such that the driving of the host vehicle F can be controlled at S119.

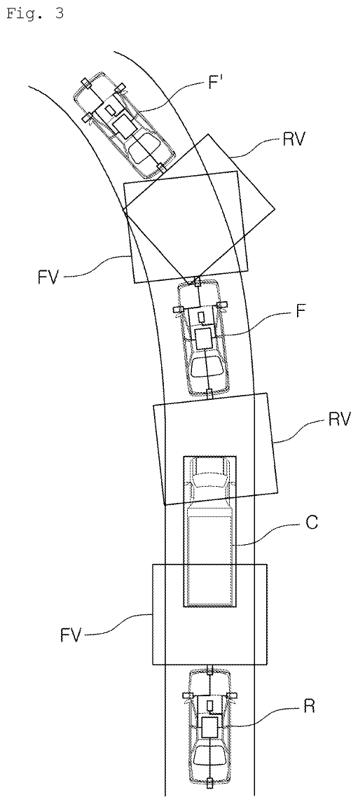

Hereinafter, elements used in the reinforcement learning will be described with reference to FIGS. 3 to 5.

FIG. 3 is a diagram illustrating the front and rear videos of platooning vehicles according to the embodiment of the present disclosure.

Referring to FIG. 3, a front vehicle F′ preceding the host vehicle F may be located in front of a host vehicle F, and a rear vehicle R may be located behind the host vehicle F. In addition, a separate vehicle C other than platooning vehicles may be located between the host vehicle F and the rear vehicle R.

A front video FV may be captured through the front camera of each vehicle, and a rear video RV may be captured through the rear camera of each vehicle.

In this case, the learning device 100 of the host vehicle F may determine mutually overlapping parts of the rear video RV of the host vehicle F and the front video FV taken from the rear vehicle R based on the rear video information of the host vehicle F and the front video information of the rear vehicle R, and may use the overlapping degree of the rear video RV and the front video FV according to the result of the determination as learning data for the reinforcement learning. This may also be applied to relationship between the front vehicle F′ and the host vehicle F as illustrated in FIG. 3.

For example, the learning device 100 may determine the overlapping degree based on the extraction of shapes or feature points marked on a road surface, such as lanes and road signs, which is illustrative, and is not necessarily limited thereto.

Meanwhile, as illustrated in FIG. 3, when a separate vehicle C other than platooning vehicles is present between the host vehicle F and the rear vehicle R, whether there is a separate vehicle C or the position of the separate vehicle C may be included in the rear video information of the host vehicle F and the front video information of the rear vehicle R.

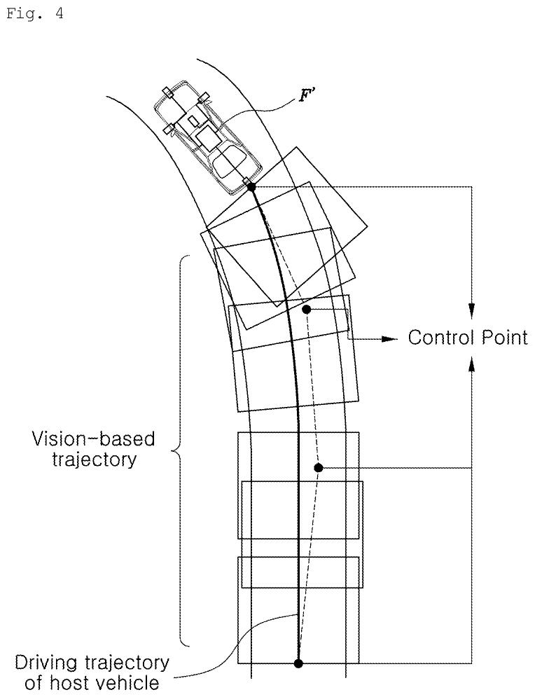

FIG. 4 illustrates an example of a process of generating control points for the driving trajectory of the front vehicle according to the embodiment of the present disclosure.

Referring to FIG. 4, the host vehicle F may generate a vision-based trajectory based on the rear video information output through the rear camera and the front video information received from the rear vehicle. Next, the host vehicle F may generate the coordinates of the control points for the driving trajectory of the host vehicle through the vision-based trajectory.

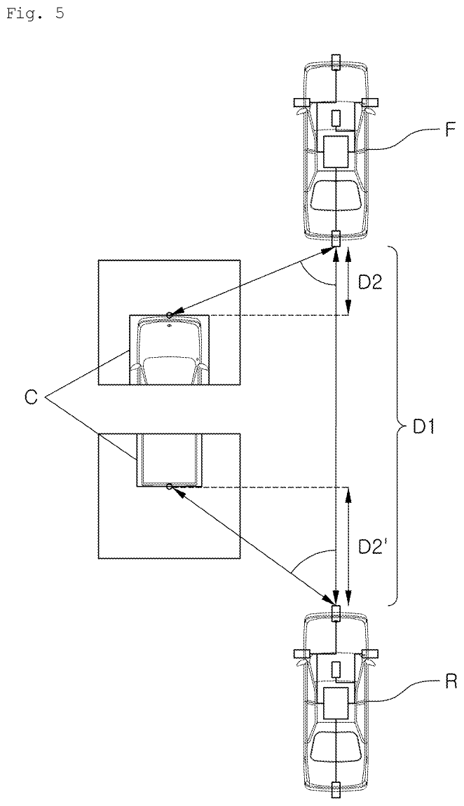

FIG. 5 illustrates an example of the process of determining distances between the host vehicle, the rear vehicle, and a separate vehicle according to the embodiment of the present disclosure. FIG. 5 assumes a case in which a separate vehicle C other than platooning vehicles is present between the host vehicle F and the rear vehicle R.

In this case, the first distance D1 between the host vehicle F and the rear vehicle R may be determined based on the received strength of a wireless signal, and a second distance D2 between the host vehicle F and a separate vehicle C may be determined based on the rear video information and the detection result of a radar provided in the host vehicle. However, this is illustrative and the method of determining the first distance D1 and the second distance D2 is not necessarily limited thereto.

In addition, from the perspective of the rear vehicle R, the first distance D1 between the rear vehicle R and the host vehicle F, and the second distance D2′ between the rear vehicle R and a separate vehicle C may be determined.

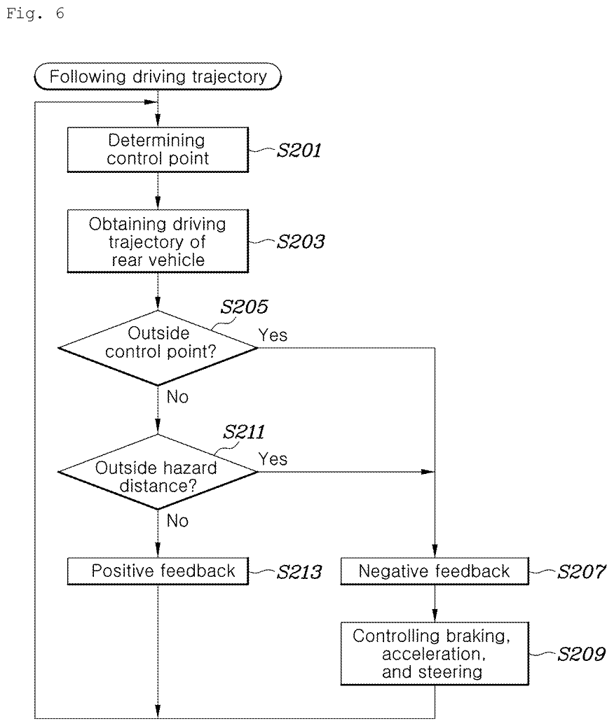

Hereinafter, the process of performing feedback of the reinforcement learning through elements described with reference to FIGS. 3 to 5 will be described with reference to FIGS. 6 to 9.

FIG. 6 is a flowchart illustrating the process of performing feedback for the reinforcement learning based on the control points for the driving trajectory of the host vehicle according to the embodiment of the present disclosure.

In FIG. 6, it is assumed that the rear vehicle follows the driving trajectory of the host vehicle according to the result of reinforcement learning that the learning device 100 performs based on the video information and the feedback signal.

First, the reward determination part 200 may determine the coordinates of the control points for the driving trajectory through the coordinates of the host vehicle at S201 and may generate the driving trajectory of the rear vehicle through the coordinates of the rear vehicle and the coordinates of the control points at S203.

The reward determination part 200 may generate the feedback signal at S207 or S213 according to the result of comparing the coordinates of the control points with the coordinates of the rear vehicle at S205 or S211.

First, the reward determination part 200 may determine whether the coordinates of the rear vehicle are outside the driving lane compared to the coordinates of the control points at S205.

When the coordinates of the rear vehicle are outside the driving lane compared to the coordinates of the control point (Yes of S205), the reward determination part 200 may output the feedback signal as negative feedback at S207. In this case, the learning device 100 may control the braking amount of the host vehicle to be increased and may control the driving of the host vehicle, such as the control of the steering angle of the host vehicle at S209.

When the coordinates of the rear vehicle are inside the driving lane compared to the coordinates of the control point (No of S205, the reward determination part 200 may determine whether the coordinates of the rear vehicle are outside the preset hazard distance from the coordinates of the control point at S211.

When the coordinates of the rear vehicle are outside the preset hazard distance from the coordinates of the control point (Yes of S211), the reward determination part 200 may output the feedback signal as negative feedback at S207. In this case, the learning device 100 may control the braking amount of the host vehicle to be increased according to negative feedback and may control the driving of the host vehicle such as the control of the steering angle of the host vehicle at S209.

When the coordinates of the rear vehicle are within the preset hazard distance from the coordinates of the control points (No of S211), the reward determination part 200 may output the feedback signal as positive feedback at S213.

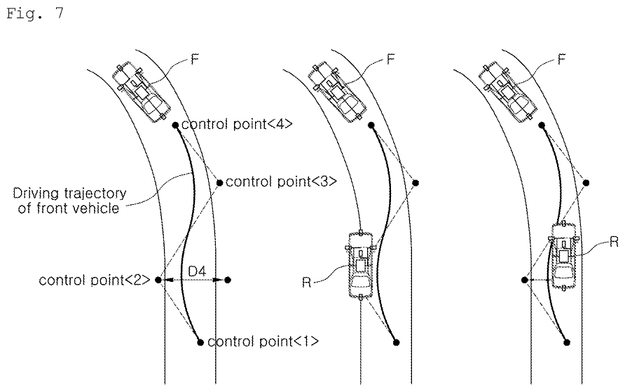

FIG. 7 is a view illustrating the process of performing feedback according to the coordinates of the rear vehicle during platooning according to the embodiment of the present disclosure.

Referring to the left side of FIG. 7, first to fourth control points <1> to <4> for the driving trajectory of the host vehicle F are illustrated.

The center of FIG. 7 corresponds to a case in which the coordinates of the rear vehicle R are outside the driving lane compared to the coordinates of the second control point <2>. In this case, the reward determination part 200 may output the feedback signal as negative feedback.

The right side of FIG. 7 corresponds to a case in which the coordinates of the rear vehicle R are inside the driving lane compared to the coordinates of the second control point <2> and are inside a hazard distance D3 from the coordinates of the second control point <2>. In this case, the reward determination part 200 may output the feedback signal as positive feedback.

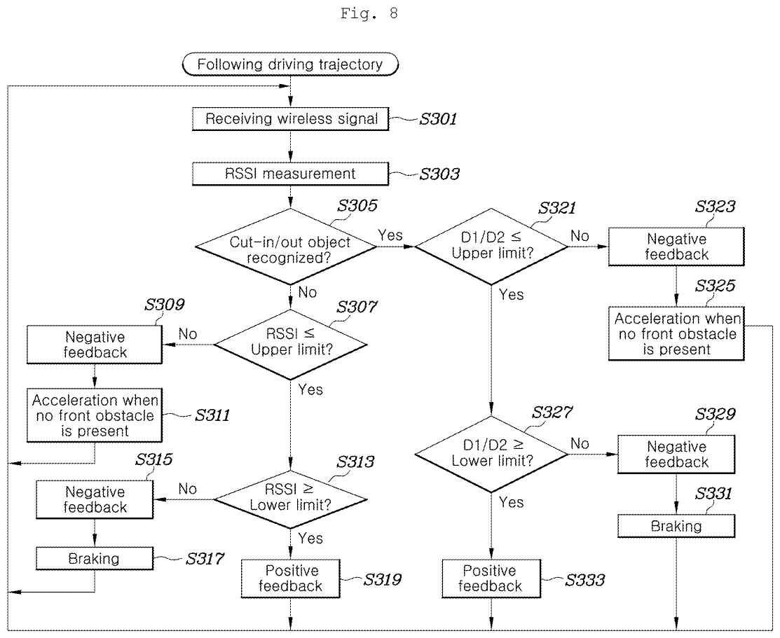

FIG. 8 is a flowchart illustrating the process of performing feedback on the reinforcement learning based on a distance between a plurality of vehicles when the host vehicle is the front vehicle in the embodiment of the present disclosure

In FIG. 8, it is assumed that the learning device 100 controls the rear vehicle to follow the driving trajectory of the host vehicle according to the result of the reinforcement learning performed based on the video information and the feedback signal.

In addition, in FIG. 8, it is assumed that the first distance D1 between the host vehicle and the rear vehicle and the second distance D2 between the host vehicle and a separate vehicle are determined by the received strength of a wireless signal received from the rear vehicle.

The reward determination part 200 may receive the wireless signal from the rear vehicle at S301 and may measure the received signal strength of the wireless signal at S303.

Next, according to whether a separate vehicle cutting in or out of the platooning formation behind the host vehicle is recognized (Yes or No of S305), the reinforcement learning and the control of the host vehicle are performed.

First, when a separate vehicle is not recognized (No of S305), the reward determination part 200 may determine whether the received signal strength of the wireless signal is included in the preset range at S307 or S313, and according to the result of the determination, the feedback signal may be output as any one of positive feedback and negative feedback at S309 or S315.

More specifically, the reward determination part 200 may determine whether the received signal strength of the wireless signal is the upper limit of the preset range or less at S307.

When the received signal strength is more than the upper limit of the preset range at (No of S307), the reward determination part 200 may determine that the first distance D1 is less than the lower limit of the preset first range and may output the feedback signal as negative feedback at S309.

In this case, when there is a front obstacle located within a predetermined range from the front of the host vehicle, the learning device 100 does not perform the acceleration control of the host vehicle to prevent collision therebetween, and when there is no front obstacle located within a predetermined range from the front of the host vehicle, the learning device 100 may control the first distance D1 to be increased through the acceleration control of the host vehicle such that the first distance D1 is included in the first range at S311.

On the other hand, when the received signal strength is the upper limit of the preset range or less (Yes of S307), the reward determination part 200 may determine whether the received signal strength is the lower limit of the preset range or more so as to determine whether the first distance D1 is included in the first range at S313.

When the received signal strength is less than the lower limit of the preset range (No of S313), the reward determination part 200 may determine that the first distance D1 is more than the upper limit of the preset first range and may output the feedback signal as negative feedback at S315.

In this case, the learning device 100 may perform the braking control of the host vehicle so that the first distance D1 is reduced and included in the first range at S317.

Meanwhile, when the received signal strength is the lower limit of the preset range or more (Yes of S313), the reward determination part 200 may determine that the first distance D1 is included in the first range and may output the feedback signal as positive feedback at S319.

Unlike this, when a separate vehicle is recognized (Yes of S305), the reward determination part 200 may determine whether the ratio D1/D2 of the first distance D1 between the host vehicle and the rear vehicle to the second distance D2 between the host vehicle and a separate vehicle is included in a preset second range at S321 or S327, and according to the result of the determination, the feedback signal may be output as any one of positive feedback and negative feedback at S323 or S329.

More specifically, the reward determination part 200 may determine whether the ratio D1/D2 of the first distance to the second distance is the upper limit of the second range or less at S321.

When the ratio D1/D2 of the first distance to the second distance is more than the upper limit of the second range (No of S321), the reward determination part 200 may determine that the proportion of the second distance D2 between the host vehicle and a separate vehicle is required to be increased when considering the first distance D1 between platooning vehicles and may output the feedback signal as negative feedback at S323.

In this case, when there is a front obstacle located within a predetermined range from the front of the host vehicle, the learning device 100 may not perform the acceleration control of the host vehicle to prevent collision therebetween, and when there is no front obstacle located within a predetermined range from the front of the host vehicle, the acceleration control of the host vehicle may be performed at S325 such that the ratio D1/D2 of the first distance to the second distance is decreased and is included in the second range.

On the other hand, when the ratio D1/D2 of the first distance to the second distance is the upper limit of the second range or less (Yes of S321), the reward determination part 200 may determine whether the ratio D1/D2 of the first distance to the second distance is included in the second range at S327.

When the ratio D1/D2 of the first distance to the second distance is less than the lower limit of the second range (No of S327), the reward determination part 200 may determine that the proportion of the second distance D2 between the host vehicle and a separate vehicle is required to be increased when considering the first distance D1 between platooning vehicles and may output the feedback signal as negative feedback at S329.

In this case, the learning device 100 may perform the braking control of the host vehicle at S331 such that the ratio D1/D2 of the first distance to the second distance is increased and is included in the second range.

Meanwhile, when the ratio D1/D2 of the first distance to the second distance is the lower limit of the second range or more (Yes of S327), the reward determination part 200 may determine that the ratio D1/D2 of the first distance to the second distance is included in the second range and may output the feedback signal as positive feedback at S333.

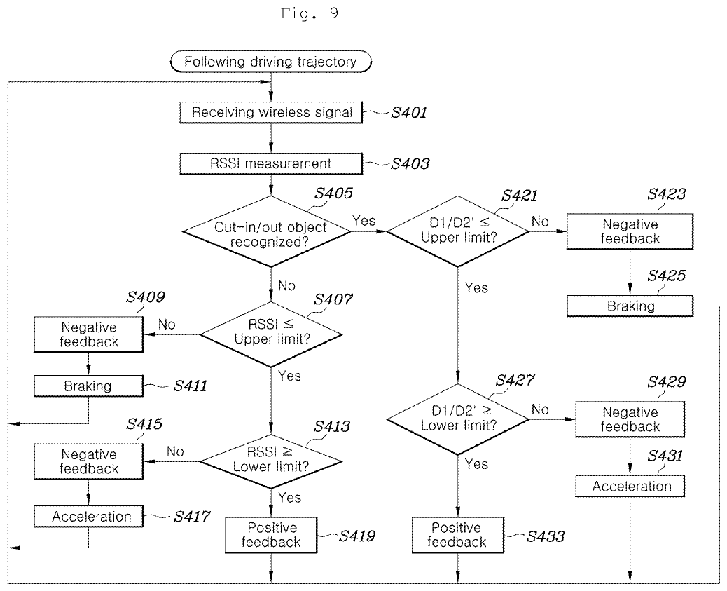

FIG. 9 is a flowchart illustrating the process of performing feedback on the reinforcement learning based on a distance between a plurality of vehicles when the host vehicle is the rear vehicle in the embodiment of the present disclosure.

All of FIGS. 8 and 9 relate to the process of performing feedback on the reinforcement learning based on a distance between a plurality of vehicles, but FIG. 9 is different from FIG. 8 based on a front vehicle in that FIG. 9 is based on a rear vehicle.

Accordingly, hereinafter, in FIG. 9, the same control is performed as in FIG. 8 except that in FIG. 9, the reinforcement learning and a feedback control are performed based on the rear vehicle, and due to the performance of the reinforcement learning and the feedback control based on the rear vehicle, the different point of FIG. 9 from FIG. 8 will be mainly described.

Referring to FIG. 9, the reward determination part 200 may receive the wireless signal from the front vehicle at S401, and may measure the received strength of the received wireless signal at S403. Next, whether the received strength of a wireless signal is included in the preset range may be determined at S407 or S413, and according to the result of the determination, the reinforcement learning and driving control may be performed at S409 and S411, or S415 and S417.

In this case, when the received strength of a wireless signal is more than the upper limit of the preset range (No of S407), the learning device 100 may control the first distance D1 to be increased through the braking control of the host vehicle such that the first distance D1 is included in the first range at S411.

When the host vehicle is a rear vehicle, to increase the first distance D1, the host vehicle is required to be slower than the front vehicle, and thus the learning device 100 performs the braking control, and the host vehicle drives while following the driving trajectory of the front vehicle, thereby further simplifying a control process by omitting the consideration of a front obstacle.

On the other hand, the received strength of a wireless signal is less than the lower limit of the preset range (No of S413, the learning device 100 may decrease the first distance D1 through the acceleration control of the host vehicle at S417.

When the host vehicle is a rear vehicle, to decrease the first distance D1, the host vehicle is required to be faster than the front vehicle, and thus the learning device 100 performs the acceleration control.

Meanwhile, when a separate vehicle other than a vehicle in platooning is recognized from the front of the host vehicle (Yes of S405), the reward determination part 200 may determine whether the ratio D1/D2′ of the first distance D1 between the host vehicle and the front vehicle to the second distance D2′ between the host vehicle and a separate vehicle is included in the preset range at S421 or S427, and according to the result of the determination, may output the feedback signal as any one of positive feedback and negative feedback at S423 or S429.

More specifically, the reward determination part 200 may determine whether the ratio D1/D2′ of the first distance to the second distance is the upper limit of the preset range or less at S421.

When the ratio D1/D2′ of the first distance to the second distance is more than the upper limit of the preset range (No of S421), the reward determination part 200 may determine that the proportion of the second distance D2′ between the host vehicle and a separate vehicle is required to be increased when considering the first distance D1 between platooning vehicles and may output the feedback signal as negative feedback at S423.

In this case, the learning device 100 may perform the braking control of the host vehicle such that the ratio D1/D2′ of the first distance to the second distance is decreased and is included in a preset range at S425.

On the other hand, when the ratio D1/D2′ of the first distance to the second distance is the upper limit of the preset range or less (Yes of S421), the reward determination part 200 may determine whether the ratio D1/D2′ of the first distance to the second distance is included in the preset range at S427.

When the ratio D1/D2′ of the first distance to the second distance is less than the lower limit of the preset range at (NO of S427), the reward determination part 200 may determine that the proportion of the second distance D2′ between the host vehicle and a separate vehicle is required to be increased when considering the first distance D1 between platooning vehicles and may output the feedback signal as negative feedback at S429.

In this case, the learning device 100 may perform the acceleration control of the host vehicle at S431 such that the ratio D1/D2′ of the first distance to the second distance is increased and is included in the preset range.

Meanwhile, when the ratio D1/D2′ of the first distance to the second distance is the lower limit of the preset range or more (Yes of S427), the reward determination part 200 may determine that the ratio D1/D2′ of the first distance to the second distance is included in the preset range and may output the feedback signal as positive feedback at S433.

According to the embodiment of the present disclosure described above, the reinforcement learning is performed by using the video information and the control points for the driving trajectory of the host vehicle during platooning, so the host vehicle can stably and efficiently lead the rear vehicle.

In addition, even when a separate vehicle cuts in the platooning formation or a separate vehicle cutting in the platooning formation cuts out of the platooning formation, the platooning formation can be stably and efficiently managed.

Although the exemplary embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. An apparatus for controlling platooning, the apparatus comprising:
a learning device which performs reinforcement learning based on a feedback signal and video information output from a camera provided in each of a host vehicle and a rear vehicle which are platooning, and controls driving of the host vehicle based on a result of the reinforcement learning such that the rear vehicle can follows a driving trajectory of the host vehicle; and
a reward determination part which obtains coordinates of the rear vehicle and generates the feedback signal by comparing the coordinates of the rear vehicle with coordinates of control points for the driving trajectory of the host vehicle.

2. The apparatus of claim 1, wherein the reward determination part transmits the coordinates of the control points to the rear vehicle such that the rear vehicle follows the driving trajectory of the host vehicle based on the control points.

3. The apparatus of claim 1, wherein the control points correspond to points which control a shape of a spline curve corresponding to the driving trajectory of the host vehicle.

4. The apparatus of claim 1, wherein when the coordinates of the rear vehicle are outside a driving lane compared to the coordinates of the control points, the reward determination part outputs the feedback signal as negative feedback.

5. The apparatus of claim 1, wherein when the coordinates of the rear vehicle are outside a preset hazard distance from the coordinates of the control points, the reward determination part outputs the feedback signal as negative feedback.

6. The apparatus of claim 1, wherein when the coordinates of the rear vehicle are inside a driving lane compared to the coordinates of the control points and are inside a preset hazard distance from the coordinates of the control points, the reward determination part outputs the feedback signal as positive feedback.

7. The apparatus of claim 1, wherein when the coordinates of the rear vehicle are outside a driving lane compared to the coordinates of the control points or are outside a preset hazard distance from the coordinates of the control points, the learning device controls one of driving direction, driving speed of the host vehicle and a combination thereof such that the driving trajectory of the host vehicle corresponds to a driving trajectory of the rear vehicle.

8. The apparatus of claim 1, wherein the reward determination part outputs the feedback signal as any one of positive feedback and negative feedback according to whether a first distance between the host vehicle and the rear vehicle is comprised in a preset first range.

9. The apparatus of claim 8, wherein when the first distance is not comprised in the preset first range, the learning device controls driving speed of the host vehicle such that the first distance is comprised in the preset first range.

10. The apparatus of claim 8, wherein the first distance is determined based on a reception strength of a wireless signal received from the rear vehicle.

11. The apparatus of claim 8, wherein the reward determination part outputs the feedback signal by considering whether a separate vehicle other than the platooning vehicle behind the host vehicle is recognized.

12. The apparatus of claim 11, wherein when the separate vehicle is recognized, the reward determination part outputs the feedback signal as any one of positive feedback and negative feedback according to whether a ratio of the first distance to a second distance between coordinates of the host vehicle and coordinates of the separate vehicle is comprised in a preset second range.

13. The apparatus of claim 12, wherein the second distance is determined based on one of rear video information output from a rear camera provided in the host vehicle, a detection result of radar provided in the host vehicle and a combination thereof.

14. The apparatus of claim 12, wherein when the ratio of the first distance to the second distance is not comprised in the second range, the learning device controls driving speed of the host vehicle such that the ratio of the first distance to the second distance is comprised in the preset second range.

15. The apparatus of claim 1, wherein the learning device controls the driving of the host vehicle through output of a steering control signal, a braking control signal, and an acceleration control signal of the host vehicle.

16. The apparatus of claim 1, wherein when controlling driving speed of the host vehicle, the learning device considers whether there is a front obstacle located within a predetermined range from a front of the host vehicle.

17. The apparatus of claim 1, wherein the video information comprises rear video information output from a rear camera of the host vehicle and front video information output from a front camera of the rear vehicle, and
the learning device determines mutually overlapping parts of the rear video of the host vehicle and the front video of the rear vehicle based on the rear video information and the front video information, and uses an overlapping degree of the rear video and the front video according to a result of the determination as learning data for the reinforcement learning.

18. The apparatus of claim 1, further comprising:
an inference neural network device that updates a parameter for a neural network comprised in the learning device, receives the video information based on the updated parameter, and controls the host vehicle such that the rear vehicle can follows the driving trajectory of the host vehicle.

19. A method for controlling platooning, the method comprising:
performing reinforcement learning based on a feedback signal and video information output from a camera provided in each of a host vehicle and a rear vehicle which are platooning;
controlling driving of the host vehicle based on a result of the reinforcement learning such that the rear vehicle can follows a driving trajectory of the host vehicle; and
generating the feedback signal by comparing coordinates of the rear vehicle with coordinates of control points for the driving trajectory of the host vehicle after obtaining the coordinates of the rear vehicle.

20. A method for controlling platooning, the method comprising:
determining whether a ratio of a first distance between coordinates of a host vehicle and coordinates of a front vehicle in platooning to a second distance between the coordinates of the host vehicle and coordinates of a separate vehicle is comprised in a preset range when the separate vehicle other than the platooning front vehicle is recognized from a front of the host vehicle in platooning;
generating a feedback signal according to a result of the determination;
performing reinforcement learning based on the feedback signal and video information output from a camera provided in each of the host vehicle and the front vehicle; and
controlling driving speed of the host vehicle such that the ratio of the first distance to the second distance is comprised in the preset range based on a result of the reinforcement learning.
